(19) United States
(12) Patent Application Publication
(10) Pub. No.: US 2011/0296981 A1
(43) Pub. Date: Dec. 8, 2011

(54) SHOCK ABSORBER

(76) Inventor: Sen-Hsiang CHOU, New Taipei City (TW)

(21) Appl. No.: 13/100,559

(22) Filed: May 4, 2011

(30) Foreign Application Priority Data
Jun. 4, 2010 (TW) 099210601

(51) Int. Cl. F15B 15/22

(52) U.S. Cl. 92/9

(57) ABSTRACT

A shock absorber has an upper cylinder, a piston valve mounted on a lower end of the upper cylinder, a free piston slidably mounted in the upper cylinder and dividing the upper cylinder into an air chamber and an upper oil chamber, a lower cylinder slidably mounted around the lower end of the upper cylinder and has a lower oil chamber. Since the free piston and the air chamber are disposed in the upper cylinder, the shock absorber has a compact structure. Furthermore, when the upper and lower cylinders slide relatively, the free piston slides accordingly to regulate volume of the upper oil chamber and to provide a damping effect. The hydraulic oil in the shock absorber does not contact air and therefore no air permeates into the hydraulic oil.

### BACKGROUND OF THE INVENTION

1. Field of the Invention The present invention relates to a shock absorber, especially to a shock absorber that is mounted in a vehicle.

2. Description of the Prior Art(s)

A shock absorber is a tubular hydraulic device that damps spring oscillations of a vehicle when the vehicle is driven across a rough ground.

With reference to FIG. 7, a first conventional shock absorber comprises an outer cylinder 92, an inner cylinder 91, a piston valve 93, a piston rod 94, a regulating valve 95, an upper oil chamber 911, a lower oil chamber 912 and a buffer chamber 921. The inner cylinder 91 is securely mounted in the outer cylinder 92 and has an upper end attached to an upper end of the outer cylinder 92. The piston valve 93 is slidably mounted in the inner cylinder 91. The piston rod 94 is slidably mounted through the upper ends of the outer and inner cylinders 92, 91 and is securely attached to the piston valve 93. The regulating valve 95 is securely mounted on a lower end of the inner cylinder 91. The upper oil chamber 911 is defined between the piston valve 93 and the upper end of the inner cylinder 91 and is filled with hydraulic oil. The lower oil chamber 912 is defined between the piston valve 93 and the regulating valve 95 and is filled with hydraulic oil. The buffer chamber 921 is defined in the outer cylinder 92.

When the piston rod 94 slides along with the piston valve 93, the hydraulic oil in the upper and lower oil chambers 911, 912 flows through the piston valve 93 and provides a damping effect to absorb shock applied on the first conventional shock absorber. Furthermore, when the piston rod 94 slides into or out of the upper oil chamber 911, the piston rod 94 occupies different volumes of space in the upper oil chamber 911. Therefore, the hydraulic oil in the upper and lower oil chambers 911, 912 further flows through the regulating valve 95 and into the buffer chamber 921 so quantities of the hydraulic oil in the upper and lower oil chambers 911, 912 are regulated. However, when the hydraulic oil flows into the buffer chamber 921, air in the buffer chamber 921 contacts and permeates into the hydraulic oil so the damping effect of the first conventional shock absorber is reduced.

With further reference to FIG. 8, in order to prevent the air from permeating into the hydraulic oil, a second conventional shock absorber has a cylinder 81, a piston valve 82, a piston rod 83, a free piston 84, an upper oil chamber 811, a lower oil chamber 812 and an air chamber 813. The piston valve 82 is slidably mounted in the cylinder 81. The piston rod 83 is slidably mounted through an upper end of the cylinder 81 and is securely attached to the piston valve 82. The free piston 84 is slidably mounted in the cylinder 81 and is disposed between the piston valve 82 and a lower end of the cylinder 81. The upper oil chamber 811 is defined between the upper end of the cylinder 81 and the piston valve 82, and is filled with hydraulic oil. The lower oil chamber 812 is defined between the piston valve 82 and the free piston 84, and is filled with hydraulic oil. The air chamber 813 is defined between the free piston 84 and the lower end of the cylinder 81.

Thus, when the piston rod 83 slides along with the piston valve 82, the free piston 84 slides accordingly and volumes of the upper and lower oil chambers 811, 812 are regulated. However, since the air chamber 913 elongates a total length of the cylinder 81 as well as the second conventional shock absorber, the second conventional shock absorber is not compactly structured.

To overcome the shortcomings, the present invention provides a shock absorber to mitigate or obviate the aforementioned problems.

### SUMMARY OF THE INVENTION

The main objective of the present invention is to provide a shock absorber. The shock absorber has an upper cylinder module, a free piston, an air chamber, an upper oil chamber, a lower cylinder module and a lower oil chamber. The upper cylinder module has an upper cylinder, a top cap mounted on an upper end of the upper cylinder and a piston valve securely mounted on a lower end of the upper cylinder. The free piston is slidably mounted in the upper cylinder. The air chamber is defined in the upper cylinder and between the top cap and the free piston. The upper oil chamber is defined in the upper cylinder and between the free piston and the piston valve. The lower cylinder module has a lower cylinder mounted around the lower end of the upper cylinder and being slidable relative to the upper cylinder and a bottom cap mounted on a lower end of the lower cylinder. The lower oil chamber is defined in the lower cylinder and between the piston valve and the bottom cap.

Since the free piston and the air chamber are disposed in the upper cylinder, the shock absorber has a compact structure. Furthermore, when the upper and lower cylinders slide relatively, the free piston slides accordingly to regulate volume of the upper oil chamber and to provide a damping effect. The hydraulic oil in the shock absorber does not contact the air and therefore no air permeates into the hydraulic oil.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a shock absorber in accordance with the present invention;

FIG. 2 is an enlarged side view in partial section of the first embodiment of the shock absorber in FIG. 1;

FIG. 3 is an enlarged side view in partial section of a second embodiment of a shock absorber in accordance with the present invention;

FIG. 4 is an enlarged exploded perspective view of a third embodiment of a shock absorber in accordance with the present invention;

FIG. 5 is an enlarged side view in partial section of the third embodiment of the shock absorber in FIG. 4;

FIG. 6 is an enlarged side view in partial section of a fourth embodiment of a shock absorber in accordance with the present invention;

FIG. 7 is a side view in partial section of a first conventional shock absorber in accordance with the prior art; and

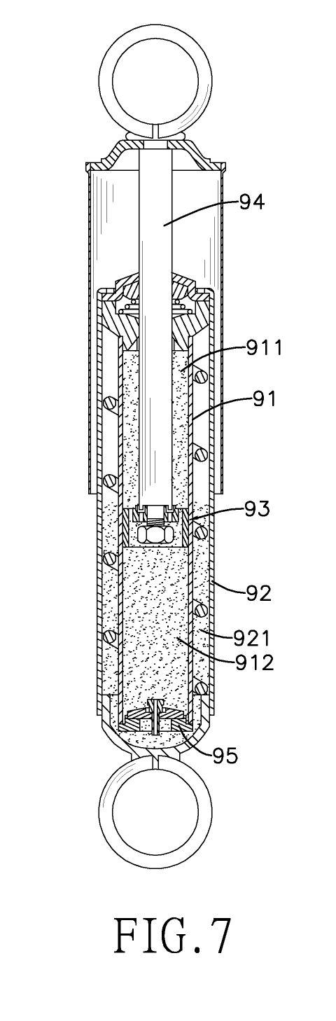

FIG. 8 is a side view in partial section of a second conventional shock absorber in accordance with the prior art.

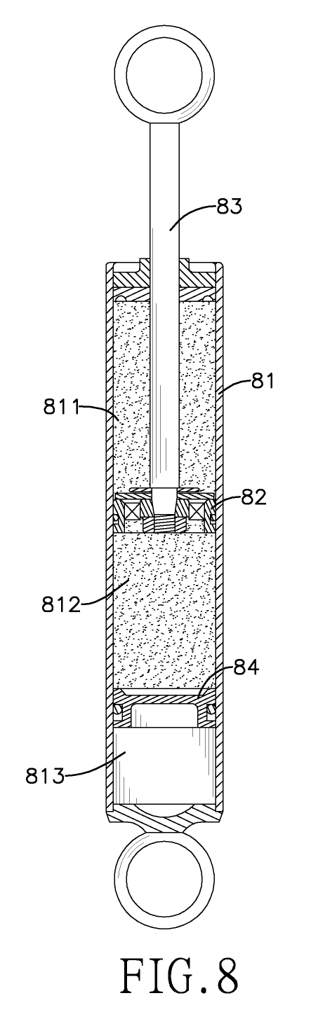

### DETAILED DESCRIPTION OF THE PREFERRED EMBODIMENTS

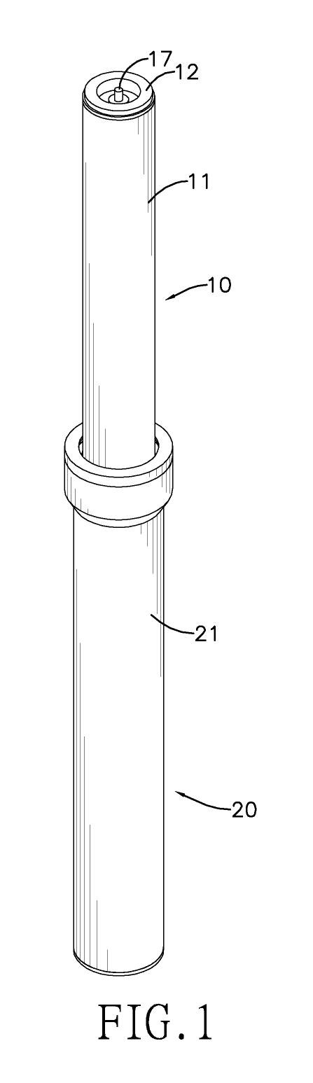

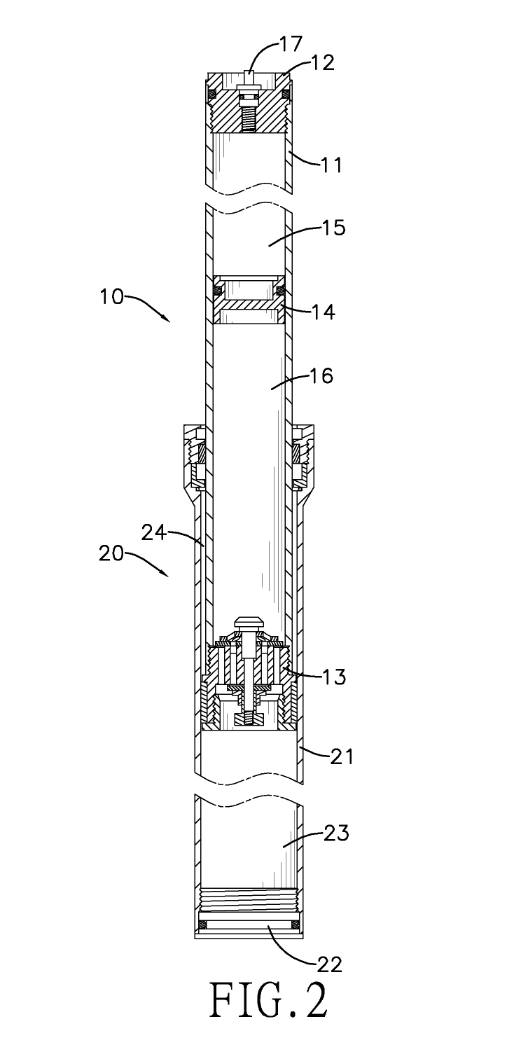

With reference to FIGS. 1 and 2, a first embodiment of a shock absorber in accordance with the present invention comprises an upper cylinder module 10, a free piston 14, an air chamber 15, an upper oil chamber 16, a lower cylinder module 20, a lower oil chamber 23, a side oil chamber 24 and an air faucet 17.

The upper cylinder module 10 has an upper cylinder 11, a top cap 12 and a piston valve 13. The top cap 12 is mounted on an upper end of the upper cylinder 11. The piston valve 13 is securely mounted on a lower end of the upper cylinder 11.

The free piston 14 is slidably mounted in the upper cylinder 11.

The air chamber 15 is defined in the upper cylinder 11 and between the top cap 12 and the free piston 14 and is filled with air.

The upper oil chamber 16 is defined in the upper cylinder 11 and between the free piston 14 and the piston valve 13 and is filled with hydraulic oil.

The lower cylinder module 20 has a lower cylinder 21 and a bottom cap 22. The lower cylinder 21 is mounted around the lower end of the upper cylinder 11 and is slidable relative to the upper cylinder 11. The bottom cap 22 is mounted on a lower end of the lower cylinder 21.

The lower oil chamber 23 is defined in the lower cylinder 21 and between the piston valve 13 and the bottom cap 22 and is filled with hydraulic oil.

Thus, when the upper cylinder 11 and the lower cylinder 21 slide relatively, the hydraulic oil in the upper and lower oil chambers 16, 23 flows through the piston valve 13 and provides a damping effect to absorb shock applied on the shock absorber.

When the shock absorber retracts and the upper cylinder 11 slides downward into the lower cylinder 21, the hydraulic oil in the lower oil chamber 23 is pressurized and flows through the piston valve 13 and into the upper oil chamber 16 to form a damping force. Consequently, the free piston 14 is pushed upwardly, a capacity of the air chamber 15 is reduced and air pressure in the air chamber 15 rises.

When the shock absorber elongates and the upper cylinder 11 slides upwardly out of the lower cylinder 21, a vacuum suction force is formed in the lower oil chamber 23 and the air pressure of the air chamber 15 pushes the free piston 14 to slide toward the piston valve 13. Therefore, the hydraulic oil flowing in the upper oil chamber 16 flows through the piston valve 13 and into the lower oil chamber 23 to form a damping force. Consequently, the capacity of the air chamber 15 is enlarged and the air pressure in the air chamber 15 drops.

With the upper cylinder 11 that slides relative to the lower cylinder 21, the shock absorber as described provides the damping effect. Since the free piston 14 and the air chamber 15 are disposed in the upper cylinder 11, the shock absorber has a compact structure. Furthermore, when the upper and lower cylinders 11, 21 slide relatively, the free piston 14 slides accordingly to regulate volume of the upper oil chamber 16. Therefore, the hydraulic oil in the shock absorber does not contact the air and no air permeates into the hydraulic oil.

The side oil chamber 24 is defined between an outer surface of the upper cylinder 11 and an inner surface of the lower cylinder 21, and is filled with hydraulic oil. When the upper and lower cylinders 11, 21 slide relatively, the hydraulic oil in the side oil chamber 24 and the lower cylinder 23 flows through a clearance formed between the piston valve 13 and the inner surface of the lower cylinder 21.

The air faucet 17 is mounted in the top cap 12. Thus, a user is able to inflate or deflate the air chamber 15 to adjust the air pressure in the air chamber 15.

Since the air chamber 15 is filled with air, the air pressure in the air chamber 15 becomes a resistance that stops the free piston 14 from sliding upward. Consequently, the resistance also stops flow of the hydraulic oil in the upper and lower oil chambers 16, 23. Therefore, when the user inflates or deflates the air chamber 15 to adjust the air pressure in the air chamber 15, the resistance applied to the free piston 14 and the hydraulic oil in the upper and lower oil chambers 16, 23, and the damping force of the shock absorber are all adjusted according to the user's requirement. Whether the shock absorber retracts or elongates, the damping force of the shock absorber mainly occurs in the hydraulic oil and the piston valve 13. Adjusting the air pressure in the air chamber 15 is only for adjusting the damping force of the shock absorber.

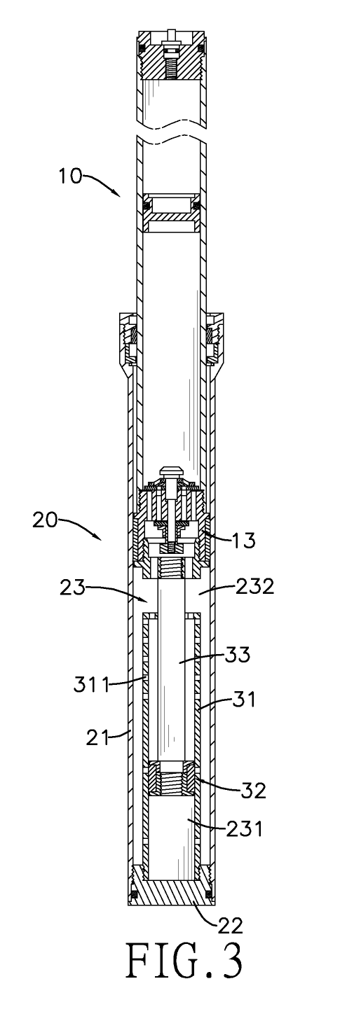

With further reference to FIG. 3, a second embodiment of a shock absorber in accordance with the present invention further comprises an inner cylinder 31, an inner piston 32 and a piston rod 33.

The inner cylinder 31 is securely mounted in the lower oil chamber 23, divides the lower oil chamber 23 into an inner oil chamber 231 and an outer oil chamber 232, and has a lower end and an upper end and multiple through holes 311. The lower end of the inner cylinder 31 is attached to the bottom cap 22. The upper end of the inner cylinder 31 corresponds to the piston valve 13. The through holes 311 are formed through the inner cylinder 31.

The inner piston 32 is slidably mounted in the inner cylinder 31.

The piston rod 33 is slidably mounted axially through the upper end of the inner cylinder 31 and has two ends respectively connected to the piston valve 13 and the inner piston 32.

When the upper cylinder 11 and the lower cylinder 12 slide relatively, the piston valve 13 drives the piston rod 33 and the inner piston 32 so the inner piston 32 slides in the inner cylinder 31. Thus, the hydraulic oil in the lower oil chamber 23 flows between the inner oil chamber 231 and the outer oil chamber 232 through the through holes 311 of the inner cylinder 31.

Preferably, the closer the through holes 311 are to the upper end of the inner cylinder 31, with the higher density the through holes 311 may be distributed. When the shock absorber retracts and the inner piston 32 is disposed adjacent to the upper end of the inner cylinder 31 and slides toward the lower end of the inner cylinder 31, the hydraulic oil in the inner oil chamber 231 is capable of flowing through most of the through holes 311 of the inner cylinder 31 to the outer oil chamber 232. Therefore, low resistance is applied to the inner piston 32. Moreover, when the shock absorber further retracts, the inner piston 32 is disposed adjacent to the lower end of the inner cylinder 31 and still slides toward the lower end of the inner cylinder 31, the hydraulic oil in the inner oil chamber 231 is only capable of flowing through part of the through holes 311 of the inner cylinder 31 to the outer oil chamber 232. Therefore, high resistance is applied to the inner piston 32.

Preferably, the closer the through holes 311 are to the upper end of the inner cylinder 31, with the lower density the through holes 311 may be distributed. When the shock absorber elongates and the inner piston 32 is disposed adjacent to the lower end of the inner cylinder 31 and slides toward the upper end of the inner cylinder 31, the hydraulic oil in the inner oil chamber 231 is capable of flowing through most of the through holes 311 of the inner cylinder 31 to the outer oil chamber 232. Therefore, low resistance is applied to the inner piston 32. Moreover, when the shock absorber further elongates and the inner piston 32 is disposed adjacent to the upper end of the inner cylinder 31 and slides toward the upper end of the inner cylinder 31, the hydraulic oil in the inner oil chamber 231 is only capable of flowing through part of the through holes 311 of the inner cylinder 31 to the outer oil chamber 232. Therefore, high resistance is applied to the inner piston 32.

By adjusting the density of the through holes 311 of the inner cylinder 31, the damping forces of the shock absorber when retracting or elongating are adjusted.

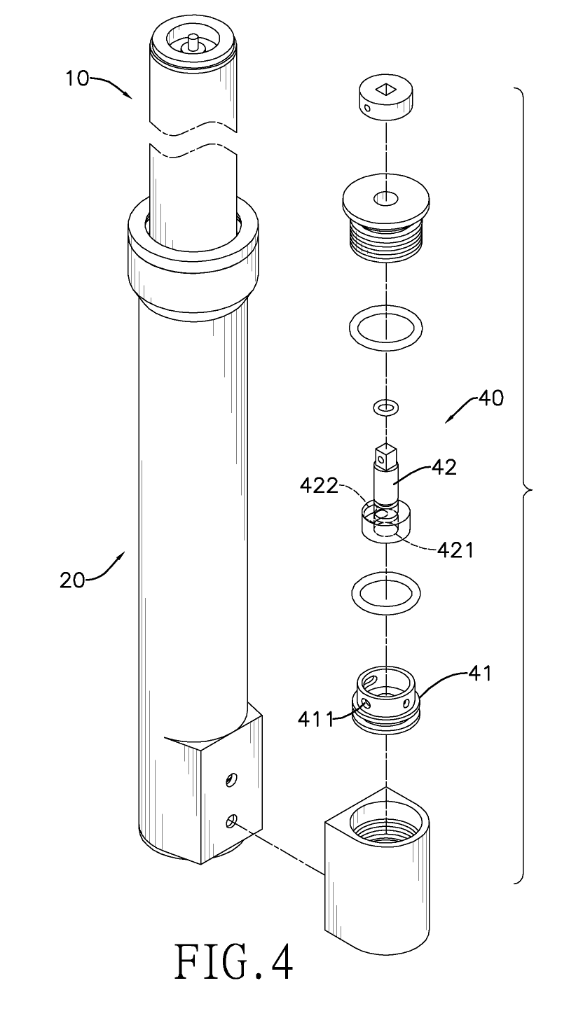

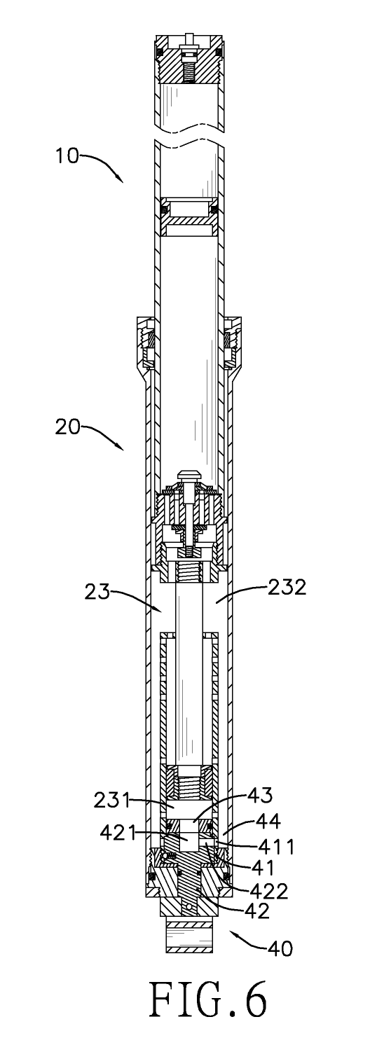

With further reference to FIGS. 4 and 6, in a third and a fourth embodiment of a shock absorber in accordance with the present invention, the shock absorber further comprises a controlling valve 40, a first channel 43 and a second channel 44.

The controlling valve 40 has an adjusting sleeve 41 and a valve rod 42. The adjusting sleeve 41 has multiple flow holes 411 formed through the adjusting sleeve 41 and having different sizes. The valve rod 42 is rotatably mounted in the adjusting sleeve 41 and has an axial hole 421 and a radial hole 422. The axial hole 421 is formed in an end of the valve rod 42. The radial hole 421 is formed through a side surface of the valve rod 42, communicates with the axial hole 421 and selectively corresponds to one of the flow holes 411 of the adjusting sleeve 41.

The first channel 43 communicates between the inner oil chamber 231 and the axial hole 421 of the valve rod 42 of the controlling valve 40 and has connectivity controlled by the controlling valve 40.

The second channel 44 communicates between the outer oil chamber 231 and the flow holes 411 of the adjusting sleeve 41 of the controlling valve 40 and has connectivity controlled by the controlling valve 40.

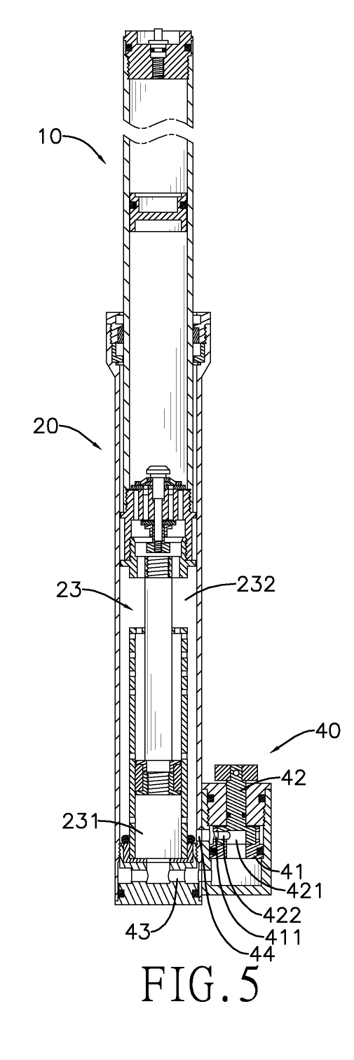

With reference to FIGS. 4 and 5, in the third embodiment of the shock absorber, the controlling valve 40 is mounted outside the lower cylinder 21.

With reference to FIG. 6, in the fourth embodiment of the shock absorber, the controlling valve 40 is mounted inside the lower cylinder 21.

When the user rotates the valve rod 42 to allow the radial hole 422 of the valve rod 42 corresponding to one of the flow holes 411 of the adjusting sleeve 41, according to the size of the corresponding flow hole 411, the connectivity of the first channel 43 and the connectivity of the second channel 44 differ. As the radial hole 422 of the valve rod 42 corresponds to a larger flow hole 411, lower resistance is applied to the hydraulic oil flowing through the controlling valve 40. As the radial hole 422 of the valve rod 42 corresponds to a smaller flow hole 411, higher resistance is applied to the hydraulic oil flowing through the controlling valve 40. Therefore, by rotating the valve rod 42, the damping effect of the shock absorber is adjusted.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A shock absorber comprising
an upper cylinder module having
an upper cylinder;
a top cap mounted on an upper end of the upper cylinder; and
a piston valve securely mounted on a lower end of the upper cylinder;
a free piston slidably mounted in the upper cylinder;
an air chamber defined in the upper cylinder and between the top cap and the free piston;
an upper oil chamber defined in the upper cylinder and between the free piston and the piston valve;
a lower cylinder module having
a lower cylinder mounted around the lower end of the upper cylinder and being slidable relative to the upper cylinder; and
a bottom cap mounted on a lower end of the lower cylinder; and
a lower oil chamber defined in the lower cylinder and between the piston valve and the bottom cap.

2. The shock absorber as claimed in claim 1 further comprising an air faucet mounted in the top cap.

3. The shock absorber as claimed in claim 1 further comprising a side oil chamber defined between an outer surface of the upper cylinder and an inner surface of the lower cylinder.

4. The shock absorber as claimed in claim 2 further comprising a side oil chamber defined between an outer surface of the upper cylinder and an inner surface of the lower cylinder.

5. The shock absorber as claimed in claim 1 further comprising
an inner cylinder securely mounted in the lower oil chamber, dividing the lower oil chamber into an inner oil chamber and an outer oil chamber and having multiple through holes formed through the inner cylinder;
an inner piston slidably mounted in the inner cylinder; and
a piston rod slidably mounted axially through the inner cylinder and having two ends respectively connected to the piston valve and the inner piston;
wherein the closer the through holes are to an upper end of the inner cylinder 31 that corresponds to the piston valve, with the higher density the through holes are distributed.

6. The shock absorber as claimed in claim 2 further comprising
an inner cylinder securely mounted in the lower oil chamber, dividing the lower oil chamber into an inner oil chamber and an outer oil chamber and having multiple through holes formed through the inner cylinder;
an inner piston slidably mounted in the inner cylinder; and
a piston rod slidably mounted axially through the inner cylinder and having two ends respectively connected to the piston valve and the inner piston;
wherein the closer the through holes are to an upper end of the inner cylinder that corresponds to the piston valve, with the higher density the through holes are distributed.

7. The shock absorber as claimed in claim 3 further comprising
an inner cylinder securely mounted in the lower oil chamber, dividing the lower oil chamber into an inner oil chamber and an outer oil chamber and having multiple through holes formed through the inner cylinder;
an inner piston slidably mounted in the inner cylinder; and
a piston rod slidably mounted axially through the inner cylinder and having two ends respectively connected to the piston valve and the inner piston;
wherein the closer the through holes are to an upper end of the inner cylinder that corresponds to the piston valve, with the higher density the through holes are distributed.

8. The shock absorber as claimed in claim 4 further comprising
an inner cylinder securely mounted in the lower oil chamber, dividing the lower oil chamber into an inner oil chamber and an outer oil chamber and having multiple through holes formed through the inner cylinder;
an inner piston slidably mounted in the inner cylinder; and
a piston rod slidably mounted axially through the inner cylinder and having two ends respectively connected to the piston valve and the inner piston;
wherein the closer the through holes are to an upper end of the inner cylinder that corresponds to the piston valve, with the higher density the through holes are distributed.

9. The shock absorber as claimed in claim 5 further comprising
a controlling valve;
a first channel communicating between the inner oil chamber and the controlling valve and having connectivity controlled by the controlling valve; and
a second channel communicating between the outer oil chamber and the controlling valve and having connectivity controlled by the controlling valve.

10. The shock absorber as claimed in claim 6 further comprising
a controlling valve;
a first channel communicating between the inner oil chamber and the controlling valve and having connectivity controlled by the controlling valve; and
a second channel communicating between the outer oil chamber and the controlling valve and having connectivity controlled by the controlling valve.

11. The shock absorber as claimed in claim 7 further comprising
a controlling valve;
a first channel communicating between the inner oil chamber and the controlling valve and having connectivity controlled by the controlling valve; and
a second channel communicating between the outer oil chamber and the controlling valve and having connectivity controlled by the controlling valve.

12. The shock absorber as claimed in claim 8 further comprising
a controlling valve;
a first channel communicating between the inner oil chamber and the controlling valve and having connectivity controlled by the controlling valve; and
a second channel communicating between the outer oil chamber and the controlling valve and having connectivity controlled by the controlling valve.

13. The shock absorber as claimed in claim 9, wherein
the controlling valve has
an adjusting sleeve having multiple flow holes formed through the adjusting sleeve and having different sizes; and
a valve rod rotatably mounted in the adjusting sleeve and having an axial hole; and
a radial hole communicating with the axial hole and selectively corresponding to one of the flow holes of the adjusting sleeve;
the first channel communicates between the inner oil chamber and the axial hole of the valve rod of the controlling valve; and
the second channel communicates between the outer oil chamber and the flow holes of the adjusting sleeve of the controlling valve.

14. The shock absorber as claimed in claim 10, wherein
the controlling valve has
an adjusting sleeve having multiple flow holes formed through the adjusting sleeve and having different sizes; and
a valve rod rotatably mounted in the adjusting sleeve and having an axial hole; and
a radial hole communicating with the axial hole and selectively corresponding to one of the flow holes of the adjusting sleeve;
the first channel communicates between the inner oil chamber and the axial hole of the valve rod of the controlling valve; and
the second channel communicates between the outer oil chamber and the flow holes of the adjusting sleeve of the controlling valve.

15. The shock absorber as claimed in claim 11, wherein
the controlling valve has
an adjusting sleeve having multiple flow holes formed through the adjusting sleeve and having different sizes; and
a valve rod rotatably mounted in the adjusting sleeve and having an axial hole; and
a radial hole communicating with the axial hole and selectively corresponding to one of the flow holes of the adjusting sleeve;
the first channel communicates between the inner oil chamber and the axial hole of the valve rod of the controlling valve; and
the second channel communicates between the outer oil chamber and the flow holes of the adjusting sleeve of the controlling valve.

16. The shock absorber as claimed in claim 12, wherein
the controlling valve has
an adjusting sleeve having multiple flow holes formed through the adjusting sleeve and having different sizes; and
a valve rod rotatably mounted in the adjusting sleeve and having an axial hole; and
a radial hole communicating with the axial hole and selectively corresponding to one of the flow holes of the adjusting sleeve;
the first channel communicates between the inner oil chamber and the axial hole of the valve rod of the controlling valve; and
the second channel communicates between the outer oil chamber and the flow holes of the adjusting sleeve of the controlling valve.

17. The shock absorber as claimed in claim 13, wherein the controlling valve is mounted outside the lower cylinder.

18. The shock absorber as claimed in claim 14, wherein the controlling valve is mounted outside the lower cylinder.

19. The shock absorber as claimed in claim 13, wherein the controlling valve is mounted inside the lower cylinder.

20. The shock absorber as claimed in claim 14, wherein the controlling valve is mounted inside the lower cylinder.
